(19) United States
(12) Patent Application Publication
(10) Pub. No.: US 2019/0213569 A1
(43) Pub. Date: Jul. 11, 2019

(54) SYSTEMS AND METHODS FOR A PORTABLE POINT-OF-SALE (POS) DEVICE

(71) Applicant: Mastercard International Incorporated, Purchase, NY (US)

(72) Inventors: Adam Kenneth Hosp, Lake St. Louis, MO (US); Ellen Christine Walz, St. Louis, MO (US); Stewart Boling, Chesterfield, MO (US); Siddique Hameed, Chesterfield, MO (US); Michael K. Forbis, St. Louis, MO (US)

(73) Assignee: Mastercard International Incorporated, Purchase, NY (US)

(21) Appl. No.: 15/863,320

(22) Filed: Jan. 5, 2018

(51) Int. Cl. G06Q 20/20

(52) U.S. Cl. CPC G06Q 20/202; H04W 4/80

(57) ABSTRACT

An apparatus and method for utilizing a portable point-of-sale device for onboarding a merchant with an interchange network is provided. The method includes the operation of coupling the portable point-of-sale device to an external display device. The method also includes the operation of downloading a merchant companion application to a merchant client device. The merchant companion application is configured to communicate directly with the portable point-of-sale device. Furthermore, the method includes the operation of configuring a network connection between the portable point-of-sale device and the interchange network utilizing the merchant companion application. Moreover, the method includes the operation of providing merchant onboarding information to the interchange network via the portable point-of-sale device utilizing the merchant companion application.

### FIELD OF THE DISCLOSURE

The field of the disclosure relates generally to point-of-sale devices and, more particularly, to portable point-of sale systems and methods for performing portable or mobile commerce operations with an interchange network.

### BACKGROUND OF THE DISCLOSURE

Typically, merchants use point-of-sale (POS) devices to process transactions for the sale of goods and/or services to a consumer. At least some known PO S devices include, for example, a typical cash register that may be used to total the cost of items purchased, accept cash payments, and determine the proper amount of change. Generally, such cash registers include or are used in combination with a payment card reader. In use, the merchant totals the sale amount on the cash register and uses the payment card reader to read the consumer's payment card (e.g., a credit card, debit card, or the like) for electronically processing the transaction. Such POS devices, however, are generally large and not easily moveable, which can be inconvenient for some merchants. Some known systems provide a mobile POS device to attempt to address such issues.

Some known mobile POS devices enable the merchant to utilize a mobile smartphone to perform as a mobile POS terminal. This approach, however, generally requires an additional hardware component(s) that attach to a mobile smartphone to read the payment card data. This may cause inconvenience to the merchant because it requires the merchant to have the additional hardware attached to their smartphone at all times in order to process transactions. In addition, the merchant is required to interact with the consumer in order accept payment for goods and/or services. This may cause inconvenience to the merchant and the consumer, especially if there are several consumers vying for the merchant's attention.

### BRIEF DESCRIPTION OF THE DISCLOSURE

This summary is not intended to identify essential features of the present invention, and is not intended to be used to limit the scope of the claims. These and other aspects of the present invention are described below in greater detail.

In one aspect, a method for utilizing a portable point-of-sale device for onboarding a merchant with an interchange network is provided. The method includes coupling the portable point-of-sale device to an external display device. The method also includes, using a merchant client device, downloading a merchant companion application configured to communicate directly with the portable point-of-sale device. In addition, the method includes configuring a network connection between the portable point-of-sale device and the interchange network utilizing the merchant companion application. Moreover, the method includes providing merchant onboarding information to the interchange network via the portable point-of-sale device utilizing the merchant companion application.

In another aspect, a portable point-of-sale device is provided. The portable point-of-sale device includes a memory device for storing data, one or more wireless communication modules, and a processor communicatively coupled to the wireless communication modules and the memory device. The processor is programmed to present an option to a merchant to download a merchant companion application to a merchant client device. In addition, the processor is programmed to establish a direct link to the merchant companion device and receive network connection information from the merchant companion application via the direct link. The processor is also programmed to establish a network connection to an interchange network via one of the wireless communication modules in accordance with the received network connection information. Moreover, the processor is programmed to receive onboarding information from the merchant companion application via the direct link and transmit the received onboarding information to the interchange network.

### BRIEF DESCRIPTION OF THE DRAWINGS

Embodiments of the present invention are described in detail below with reference to the attached drawing figures, wherein:

FIG. 1 is a simplified block diagram of an exemplary payment card network system including a portable point-of-sale (POS) device;

FIG. 2 is a schematic view of the POS device shown in FIG. 1;

FIG. 3 is an example configuration of a consumer mobile computing device for use with the payment card network system shown in FIG. 1;

FIG. 4 is an example configuration of a server system for use in the payment card network system shown in FIG. 1;

FIG. 5 is a block diagram of a transaction card account system showing data flow among the consumer mobile computing device of FIG. 3, a payment processor, and a merchant processor.

FIG. 6 is a flowchart illustrating an exemplary merchant onboarding process for onboarding a merchant using the POS device shown in FIG. 1;

FIG. 7 is a flowchart illustrating an exemplary merchant platform setup process for setting up the POS device shown in FIG. 1 to display the merchant's goods and/or services on an external display device;

FIG. 8 is a flowchart illustrating an exemplary consumer transaction process utilizing the POS device shown in FIG. 1.

The figures are not intended to limit the present invention to the specific embodiments they depict. The drawings are not necessarily to scale. Like numbers in the Figures indicate the same or functionally similar components.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized and changes may be made without departing from the scope of the claims. The following description is, therefore, not limiting. It is contemplated that the invention has general application to identifying and verifying entities requesting access to confidential information and/or financial services. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly characterized, the present invention relates to systems and methods for portable point-of-sale (POS) solutions. More particularly, the disclosed embodiments provide a system and computer-implemented method for onboarding merchants and setting up portable point-of-sale devices for displaying the merchant's goods and/or services. In one example embodiment, a portable POS device is configured for use with a payment card processing network such as, for example, an interchange network. The POS device broadly includes a memory device and a processor in communication with the memory device with the processor being programmed to communicate with the interchange network to transmit merchant information and initiate payment transactions. The POS device receives a merchant's identification data and transmits it to the interchange network to facilitate onboarding the merchant with the interchange network. The POS device is configured to display the merchant's goods and/or service on an external display device to facilitate merchant sales activity in various locations. The POS device is configured to provide interactive purchase scenarios to a consumer.

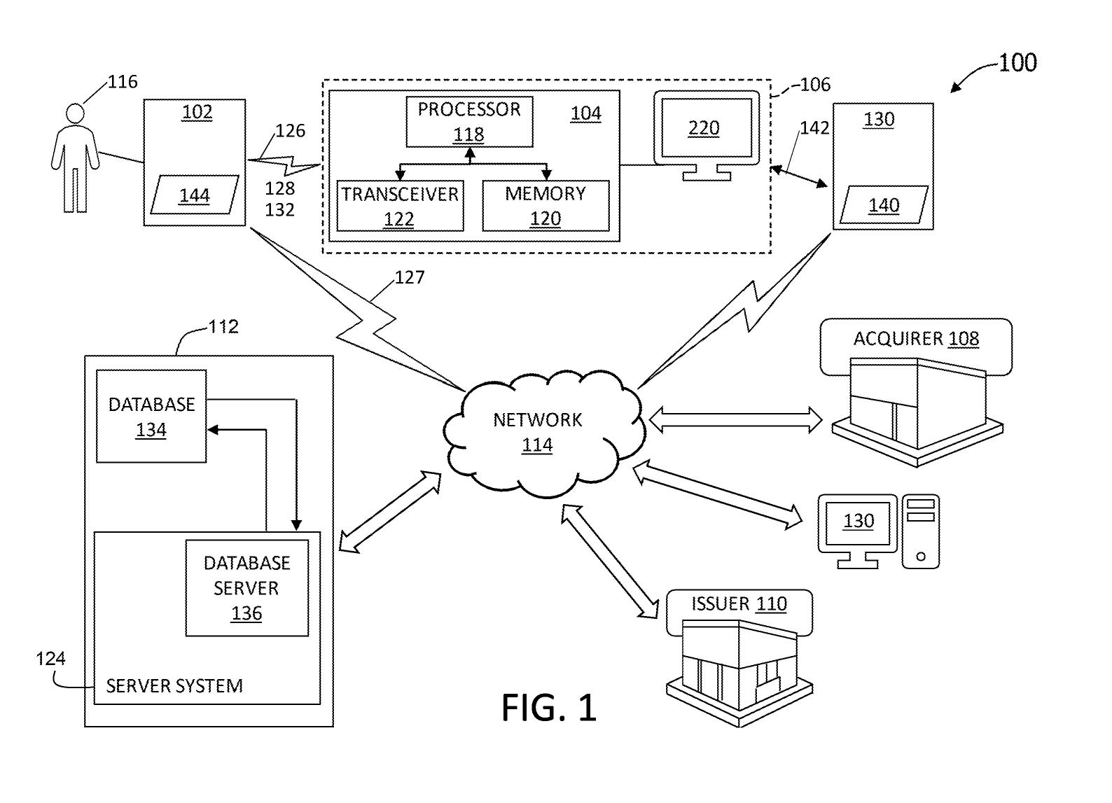

FIG. 1 is a simplified block diagram of an exemplary payment card network system 100 including a portable point-of-sale (POS) device 104 in accordance with one embodiment of the present disclosure. The payment card network system 100 may be utilized by merchants as part of a process of initiating an authorization request and performing a transaction as described herein via an interchange network 112. In addition, the payment card network system 100 is a transaction card account system including a consumer mobile computing device 102, which a consumer 116 may use to conduct electronic transactions and/or record payments for electronic transactions related to purchase of a merchant's goods or services.

The payment card network system 100 enables payment-by-card transactions in which a merchant 106, acquirers 108, and/or card issuers 110 do not need to have a one-to-one relationship. The POS device 104 is a portable, specially programmed computing device that connects to the interchange network 112 to facilitate transactions with the merchant 106 where ever the merchant 106 chooses to setup a transaction location. In addition, in some embodiments, the POS device 104 implements a process to setup or onboard the merchant 106 with the interchange network 112.

In the example embodiment, the payment card network system 100 generally includes the merchant 106 (via the POS device 104), the acquirers 108, the interchange network 112, and the issuers 110, coupled in communication via a communications network 114. The network 114 includes, for example and without limitation, one or more of a local area network (LAN), a wide area network (WAN) (e.g., the Internet, etc.), a mobile network, a virtual network, and/or any other suitable public and/or private network capable of facilitating communication among the POS device 104, the acquirers 108, the interchange network 112, and/or the issuers 110. In some embodiments, the network 114 may include more than one type of network, such as a private payment transaction network provided by the interchange network 112 to the acquirers 108 and the issuers 110 and, separately, the public Internet, which may facilitate communication between the POS device 104, the interchange network 112, the acquirers 108, and one or more consumer mobile computing devices 102, etc.

Embodiments described herein may relate to a transaction card system, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated. As used herein, financial transaction data includes a unique account number associated with an account holder using a payment card issued by an issuer, purchase data representing a purchase made by the cardholder, including a type of merchant, amount of purchase, date of purchase, and other data, which may be transmitted between any parties of the payment card network system 100.

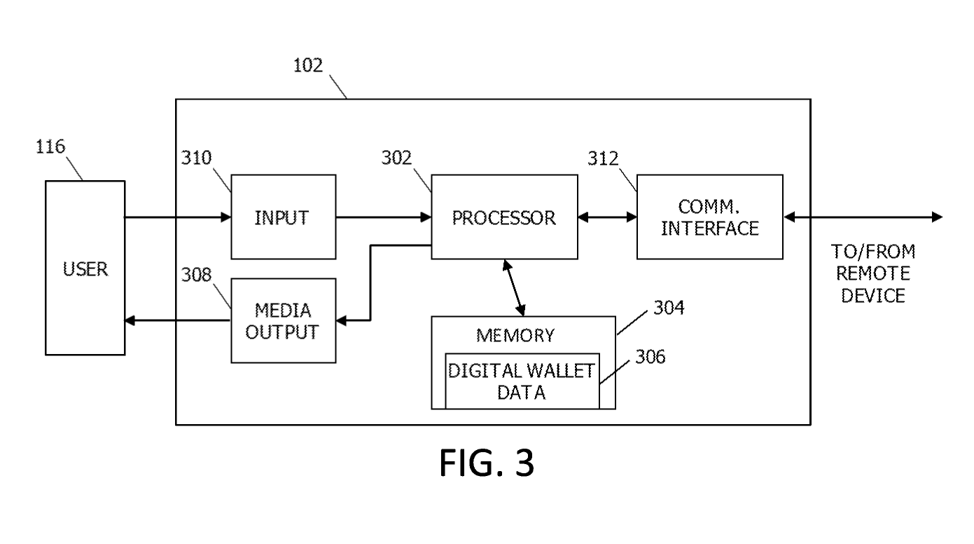

In a typical transaction card system, a financial institution called the “issuer” issues a transaction card, such as a credit card, to a cardholder or consumer 116, who uses the transaction card to tender payment for a purchase from the merchant 106. The consumer 116 may input information from transaction card into the consumer mobile computing device 102 and store the information as digital wallet data 306 (broadly, payment credentials) (shown in FIG. 3). The merchant 106 is typically associated with products, for example, and without limitation, goods and/or services, that are offered for sale and are sold to the consumer 116. The merchant 106 includes, for example, a physical location and/or a virtual location. A physical location includes, for example, a physical location of the POS device 104 and a virtual location includes, for example, an Internet-based store-front.

To accept payment from the consumer 116 with, for example, the digital wallet data 306, the merchant 106 must normally establish an account with a financial institution that is part of the payment card network system 100. This financial institution is usually called the “merchant bank,” the “acquiring bank,” or the acquirer 108. When the consumer 116 submits payment for a purchase with the consumer mobile computing device 102 using the digital wallet data 306, the merchant 106 requests authorization from the acquirer 108 for the amount of the purchase. The request is usually performed using the POS device 104 that reads the consumer's account information from the digital wallet data 306 and communicates electronically with the transaction processing computers of the acquirer 108. Alternatively, the acquirer 108 may authorize a third party to perform transaction processing on its behalf. In this case, the POS device 104 will be configured to communicate with the third party. Such a third party is usually called a “merchant processor,” an “acquiring processor,” or a “third party processor.”

Using the interchange network 112, computers of the acquirer 108 or merchant processor will communicate with computers of the issuer 110 to determine whether the cardholder's account is in good standing and whether the purchase is covered by the cardholder's available credit line. Based on these determinations, the request for authorization will be declined or accepted. If the request is accepted, an authorization code is issued to the merchant 106.

When a request for authorization is accepted, the available credit line of the cardholder's account is decreased. Normally, a charge for a payment card transaction is not posted immediately to the cardholder's account because bankcard associations, such as Mastercard International Incorporated, have promulgated rules that do not allow the merchant 106 to charge, or “capture,” a transaction until the purchased goods are shipped or the purchased services are delivered. However, with respect to at least some debit card transactions, a charge may be posted at the time of the transaction. When the merchant 106 ships or delivers the goods or services, the merchant 106 captures the transaction by, for example, appropriate data entry procedures on the point-of-sale terminal. This may include bundling of approved transactions daily for standard retail purchases. If the cardholder 116 cancels a transaction before it is captured, a “void” is generated. If the cardholder 116 returns goods after the transaction has been captured, a “credit” is generated. The interchange network 112 and/or the issuer 110 stores the transaction card information, such as, and without limitation, a type of merchant, a merchant identifier, a location where the transaction was completed, an amount of purchase, and a date and time of the transaction, in a transaction database 134.

After a purchase has been made, a clearing process occurs to transfer additional transaction data related to the purchase among the parties to the transaction, such as the acquirer 108, the interchange network 112, and the issuer 110. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

For debit card transactions, when a request for a personal identification number (PIN) authorization is approved by the issuer 110, the cardholder's account is decreased. Normally, a charge is posted immediately to the cardholder's account. The interchange network 112 transmits the approval to the acquirer 108 for distribution of goods/services or information, or cash in the case of an automated teller machine (ATM).

After a transaction is authorized and cleared, the transaction is settled among the merchant 106, the acquirer 108, and the issuer 110. Settlement refers to the transfer of financial data or funds among the merchant's account, the acquirer 108, and the issuer 110 related to the transaction. Usually, transactions are captured and accumulated into a “batch,” which is settled as a group. More specifically, a transaction is typically settled between the issuer 110 and the interchange network 112, and then between the interchange network 112 and the acquirer 108, and then between the acquirer 108 and the merchant 106.

With continued reference to FIG. 1, the interchange network 112 includes a server system 124, which is, for example, and without limitation, a server, a network of multiple computing devices, a virtual computing device, or the like. In addition, in some embodiments, the payment card network system 100 may also include one or more merchant or client sub-systems 130 (also referred to as client systems) coupled in communication to the server system 124. The client systems 130 are computers including a web browser and a memory device, such that the server system 124 is accessible to the client systems 130 using, for example, the Internet. The client systems 130 are interconnected to the Internet through one or more interfaces including a network, such as a local area network (LAN) or a wide area network (WAN), dial-in-connections, cable modems, and special high-speed ISDN lines. The client systems 130 can be any device capable of interconnecting to the Internet including, for example, a web-based smartphone, a personal digital assistant (PDA), or any other web-based connectable equipment.

As described above, the payment card network system 100 includes one or more POS devices 104 that are connected to the server system 124, and in some embodiments, may be connected to the client systems 130. The POS devices 104 are interconnected to the Internet through one or more interfaces including a network, such as a local area network (LAN) or a wide area network (WAN), dial-in-connections, cable modems, wireless modems, and special high-speed ISDN lines. The POS devices 104 can be any computing device capable of interconnecting to the Internet and including an input device capable of reading information from a user's financial transaction card, including the digital wallet data 306.

Furthermore, as described above, the payment card network system 100 also includes at least one consumer mobile computing device 102 (e.g., a smartphone or other computing device used by the consumer to complete transactions), which is configured to communicate with the POS devices 104. In one embodiment, the consumer mobile computing device 102 is associated with or controlled by a user making a purchase using a transaction card account and the payment card network system 100. The consumer mobile computing device 102 may be interconnected to the Internet through one or more interfaces including a network, such as a LAN or a WAN, dial-in-connections, cable modems, wireless connections, and special high-speed ISDN lines. The consumer mobile computing device 102 can be any computing device capable of interconnecting to the Internet including a mobile web-based device, smartphone, PDA, or other mobile web-based connectable equipment. In the example embodiment, the consumer mobile computing device 102 is configured to communicate with the PO S device 104 to transmit, for example, the digital wallet data 306 to the POS device 104. The consumer mobile computing device 102 is configured to communicate with the POS device 104 using various outputs including, for example, Bluetooth communication, radio frequency communication, near field communication (NFC), network-based communication, and the like.

In the example embodiment, the consumer mobile computing device 102 is positioned or located within a predetermined distance of the POS device 104. The consumer mobile computing device 102 is detected by and communicates with the PO S device 104. The POS device 104 is portable and may be positioned in various locations that the merchant 106 finds desirable for selling its goods and/or services, for example, and without limitation, kiosks in public spaces, booth displays at public events, a farmer's market, various locations in a store, and the like.

In the example embodiment, the POS device 104 includes a processor 118, a memory device 120, and a transceiver 122 (broadly, a wireless communication module). In addition, the consumer mobile computing device 102 includes at least a processor 302, a memory device 304, and a transceiver 312 (broadly, a wireless communication module) (each shown in FIG. 3). When positioned within the predetermined distance, the POS device 104 sends an initial signal wirelessly over a wireless connection 126 to transceiver 312 of the consumer mobile computing device 102. The initial signal is processed by the processor 302 and a response signal is sent to the transceiver 122 of the POS device 104. The response signal is processed by the processor 118 and stored within the memory device 120.

In another embodiment, the POS device 104 sends the initial signal to the consumer mobile computing device 102 over the network 114. The initial signal is processed by the processor 302 and a response signal is sent to the POS device 104 over the network 114 via a wireless connection 127 established between the network 114 and the consumer mobile computing device 102. The response signal is processed by the processor 118 and stored within the memory device 120.

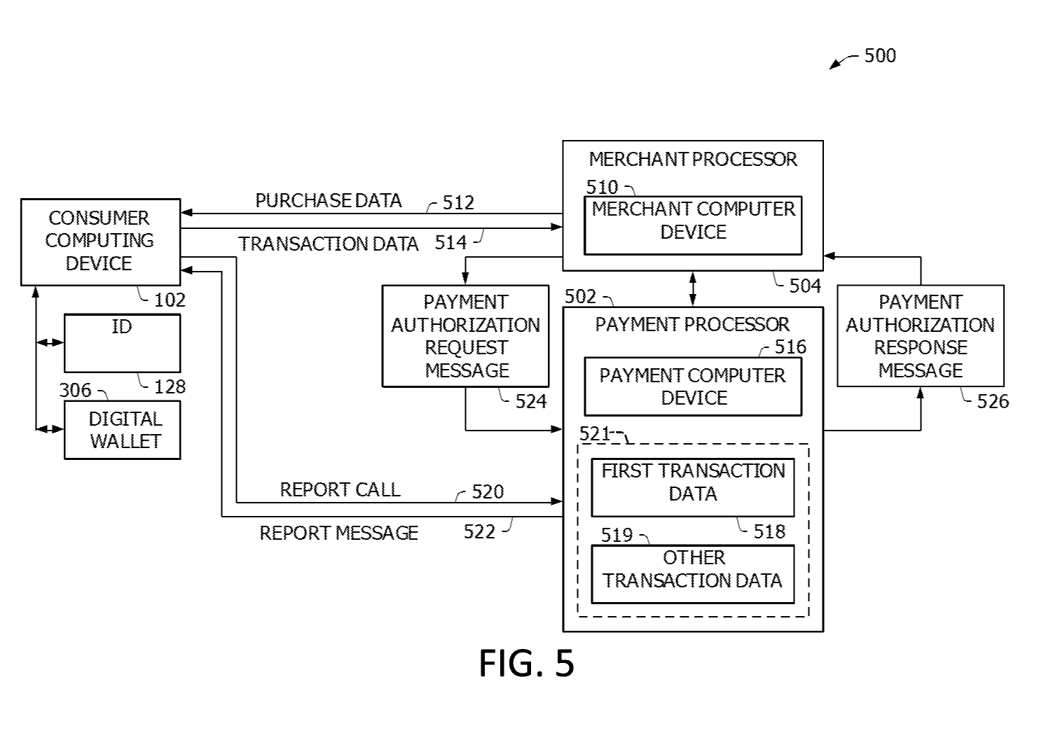

In one embodiment, the initial signal sent from the POS device 104 to the consumer mobile computing device 102 triggers the consumer mobile computing device 102 to transmit a consumer mobile computing device identifier (ID) 128 to the POS device 104. In addition, a POS device ID 132 is transmitted by the POS device 104 to the consumer mobile computing device 102. The POS device 104 processes the consumer mobile computing device ID 128 using the processor 118 and transmits it to the server system 124 via the network 114. In another embodiment, the POS device 104 transmits the consumer mobile computing device ID 128 to the client system 130, where it is subsequently transmitted to server system 124 via the network 114. In the example embodiment, the server system 124 is associated with a payment processor of a payment network (shown in FIG. 5).

The POS device 104 is configured to receive the digital wallet data 306 from the consumer mobile computing device 102 over the wireless connection 126 or 127. As described herein, when a user performs a transaction at a merchant location, digital wallet data 306 is generated. The digital wallet data 306 is transmitted across computer devices as a digital wallet data message. In one embodiment, when the user performs a transaction at the POS device 104 associated with a merchant, the digital wallet data 306 for the transaction is transmitted to the server system 124 and/or to a client system 130, where it is subsequently transmitted to the server system 124, via the network 114. The server system 124 processes the digital wallet data 306 in the manner described herein.

The digital wallet data message may include a transaction amount, a transaction date, account data related to the transaction card used to perform the transaction (e.g., primary account number associated with transaction card, card expiration date, card issuer, card security code, or the like), a merchant identifier, stock-keeping unit (SKU) data relating to the goods or services purchased from the merchant, or the like. In one embodiment, the digital wallet data message also includes location data. As used herein, address data, city data, state data, zip or postal code data, country data, merchant location identifier data, IP address data, MAC address data, or the like. In another embodiment, the digital wallet data message further includes demographic data. This demographic data may correspond to the user's age, place of origin, gender, and the like.

A database server 136 is connected to the transaction database 134. In one embodiment, the transaction database 134 is stored on the server system 124 and can be accessed by users at one of the client systems 130 by logging onto the server system 124 through one of the client systems 130. In an alternative embodiment, the transaction database 134 is stored remotely from the server system 124 and may be non-centralized. The transaction database 134 may store transaction data generated as part of sales activities conducted over the bankcard network including data relating to merchants, account holders or customers, and purchases. The transaction database 134 may also store account data including at least one of a user name, a user address, an account number, and other account identifiers. The transaction database 134 may also store merchant data including a merchant identifier that identifies each merchant registered to use the payment account card network, and instructions for settling transactions including merchant bank account information. The transaction database 134 may also store primary account numbers (PANs) or bank account numbers for various parties including merchants and customers, along with payment verification identifiers and other data necessary to implement the system and processes described herein.

In the example embodiment, the following associations may be made: one of the client systems 130 may be associated with an acquirer, a user, or a customer; another one of the client systems 130 may be associated with an issuer; the POS device 104 may be associated with a merchant; the consumer mobile computing device 102 may be associated with a customer; and the server system 124 may be associated with a payment network or interchange network.

In the example embodiment, server system 124 is associated with a payment network and may be referred to as a payment computer device. The server system 124 may be used for processing transaction data and for registering users into a plurality of programs offered by the payment network. In addition, at least one of the client systems 130 may include a computer system associated with an issuer of a transaction card. Accordingly, the server system 124 and the client systems 130 may be utilized to process transaction data relating to purchases made by a user utilizing a transaction card that is processed by the payment network and issued by the associated issuer. Another client system 130 may be associated with a user or a user seeking to register access information or process a transaction with at least one of the payment network, the issuer, or the POS device 104.

The embodiments illustrated and described herein as well as embodiments not specifically described herein but within the scope of aspects of the invention constitute exemplary means for performing financial transactions, and more particularly, constitute exemplary means for performing a financial transaction using a portable POS device. For example, the server system 124, the POS device 104, the client system 130, the consumer mobile computing device 102, or any other similar computer device, programmed with computer-executable instructions to execute processes and techniques with a processor as described herein, constitutes exemplary means for enabling a user to conduct, manage, and track electronic transactions relating to purchases of a merchant's good and services using a consumer mobile computer device.

In one embodiment, the server system 124 inhibits fraudulent purchases by requiring specific pieces of information to be included in a transaction approval request message (e.g., the authorization message) sent from the POS device 104. The required information may include, for example, user account data, the consumer mobile computing device ID 128, and a registered PAN in order to approve purchase transactions. Accordingly, transactions for services can be restricted to those associated with specific location data to reduce fraud.

The payment card network system 100 described herein is configured to approve “cardless” electronic transactions made using a PAN having the consumer mobile computing device 102 “registered” thereto using, for example, wireless communication, unique user account data, and/or the location (e.g., GPS coordinates) of the computing devices (e.g., the consumer mobile computing device 102 and the POS device 104). The electronic transaction is cardless in that the cardholder does not have to physically handle the transaction card during the electronic transaction. For example, the cardholder 116 receives the transaction card from an issuer 110, and enters registration information into the consumer mobile computing device 102 to register with a payment processing system that enables the consumer mobile computing device 102 to electronically initiate cardless electronic transactions. Registration information includes, for example, and without limitation, transaction card information, contact information (e.g., an email address and/or a telephone number), billing information, and/or shipping information. Transaction card information may include, for example, a transaction card or payment account identifier (e.g., a PAN, a partial account number, and/or a card name), a security code, and/or an expiry date. Shipping information may include, for example, a delivery address and/or delivery instructions. In one embodiment, the cardholder enters, among other data inputs, a PAN into the consumer mobile computing device 102. The PAN is stored in the memory device 304. In another embodiment, the PAN is entered into the consumer mobile computing device 102, but is then sent on to a payment processor computing device where it is tokenized, and the token PAN is returned to the consumer mobile computing device 102 for storage.

Additionally, the cardholder 116 may provide a biometric sample that is to be associated with the other registration information provided that is stored in the consumer mobile computing device 102. Biometric samples include, without limitation, a fingerprint image, a voice recording, a retinal image, facial recognition, palm print image, iris recognition, and the like. The biometric sample is unique to the cardholder 116 and difficult to duplicate and/or forge by an unauthorized user. The biometric sample is stored and associated with a biometric identifier. Additionally, the biometric identifier is associated with the stored registration information and facilitates secure authorization of transactions initiated using any of the registration information. A biometric input device in communication with the consumer mobile computing device 102 may be used for the cardholder to enter the biometric sample. For example, the consumer mobile computing device 102 may include an integral fingerprint or palm reader/scanner, retinal or iris reader/scanner, and/or voice reader/recorder.

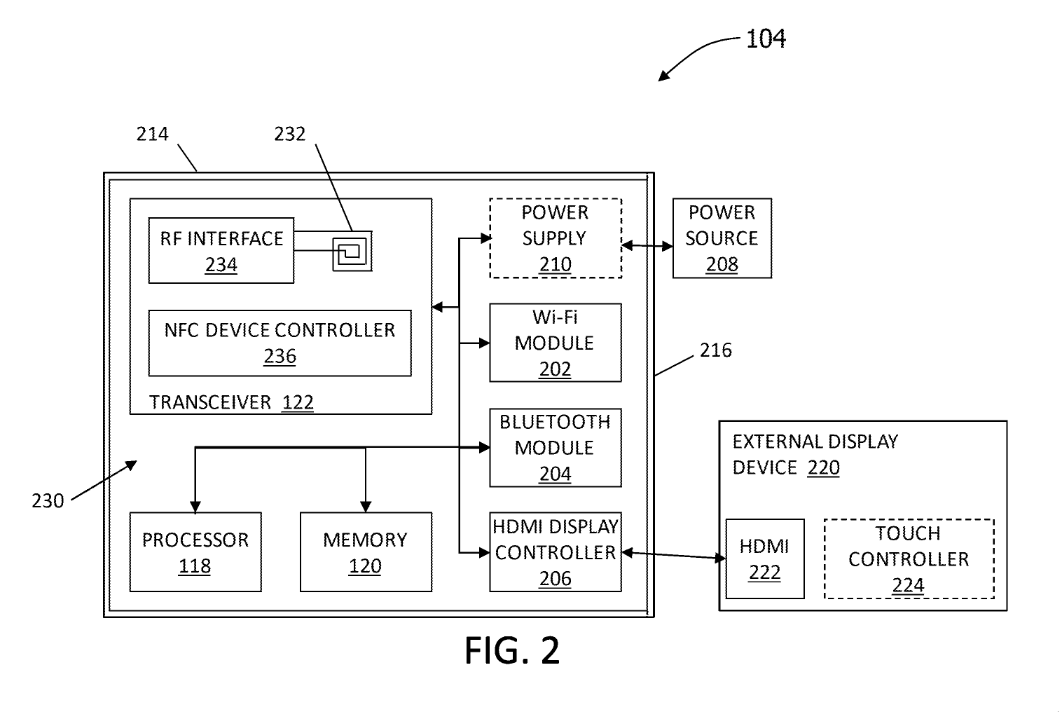

FIG. 2 is a schematic view of the POS device 104. In the example embodiment, the POS device 104 is a small form factor computing device configured to attach to an external display device 220, and as such, the POS device 104 does not include an integrated display. The external display device 220 can include, for example, and without limitation, a monitor, a television, a liquid crystal display (LCD), an organic light emitting diode (OLED) display, or an “electronic ink” display, that communicates in accordance with a High-Definition Multimedia Interface (HDMI) standard (e.g., HDMI 1.3 or 1.4, implementing the Consumer Electronics Association/Electronic Industries Alliance 861-E standard, 2012). The HDMI standard also includes content protection known as High-bandwidth Digital Content Protection (HDCP) which may encrypt a signal if required by a source device. Further included in the HDMI standard is Consumer Electronics Control (CEC) that allows a user to control other CEC-enabled devices that are connected through HDMI using a single controller. Individual devices may command and control each other using CEC. HDMI CEC may comprise a one-wire bidirectional serial bus that may use the standard AV.link protocol (e.g., European Committee for Electrotechnical Standardization (CENELEC) EN 50157-1) to perform remote control functions.

As described herein, the POS device 104 generally includes the processor 118, the memory device 120, and the transceiver 122. In addition, the POS device 104 includes an integrated Wi-Fi component 202 (e.g., implementing the Institute of Electrical and Electronics/IEEE 802.11 family of standards) and a Bluetooth component 204 (e.g., implementing capabilities in accordance to the Bluetooth Alliance standards, including Bluetooth classic and Bluetooth Low Energy (BLE)) (broadly, wireless communication modules). Moreover, the POS device 104 includes an HDMI display controller 206. However, the POS device 104 typically does not include its own power supply; it typically relies upon an external power source 208 to receive power. In some embodiments, the POS device may receive power from the external display device 220 via the HDMI connection. Alternatively, in some embodiments, the POS device 104 may include an internal power supply 210 (e.g., a battery or other self-contained power source).

The processor 118 includes one or more processing units (e.g., in a multi-core configuration) for executing computer readable instructions. The instructions may be executed within a variety of different operating systems (OS) on the POS device 104, such as UNIX, LINUX, Microsoft Windows®, etc. More specifically, the instructions may cause various data manipulations on data stored in the memory device 120 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

In the example embodiment, the processor 118 may be implemented as one or more cryptographic processors. A cryptographic processor may include, for example, dedicated circuitry and hardware such as one or more cryptographic arithmetic logic units (not shown) that are optimized to perform computational intensive cryptographic functions. A cryptographic processor may be a dedicated microprocessor for carrying out cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions.

Because the POS device 104 may be widely deployed by various merchants 106, it is impractical to manually update software for each POS device 104. Therefore, the system 100 provides a mechanism for automatically updating the software on the POS device 104. For example, the updating mechanism may be used to automatically update any number of components and their drivers, both network and non-network components, including system level (OS) software components. In some embodiments, the POS device 104 components are dynamically loadable and unloadable; thus, they may be replaced in operation without having to reboot the OS.

In the example embodiment, the HDMI display controller 206 includes HDMI/HDCP capabilities with CEC to drive the external display device 220. Through a secure connection 212, such as an HDMI/HDCP connection, the POS device 104 communicates with the external display device 220 via its HDMI controller 222. As shown in FIG. 2, the external display device 220 may optionally include a touch controller 224 for support of touch capability. Incorporating the touch controller 224 into the display 220 may facilitate preventing access by malicious software, thereby ensuring that touch input may be used for secure transactions.

In the example embodiment, the POS device 104 includes a housing 214 enclosing the components described above. In addition, the POS device includes circuitry 230 configured to communicate with the consumer mobile computing device 102 (shown in FIG. 1). The circuitry 230 may include, for example, leads, connectors, NFC-enabled circuitry, Wi-Fi-enabled circuitry, and Bluetooth-enabled circuitry. The housing 214 is configured to seal the circuitry 230, which is susceptible to degradation from the ambient environment. In one embodiment, the circuitry 230 is hermetically sealed in the housing 214. For example, in one embodiment, the circuitry 230 is completely and permanently encased within the housing 214. In other words, the housing 214 and the circuitry 230 are intended to remain as a single, inseparable unit throughout the life of the POS device 104. In this embodiment, the circuitry 230 can be made by overmolding the housing 214 onto the circuitry 230 using any known overmolding technique. It is understood that the housing 214 can be formed separately from the circuitry 230 and that the circuitry 230 can be placed into and sealed within the housing 214 in a separate operation. It is also understood that the housing 214 can be oversized with respect to the circuitry 230 so that the circuitry 230 can be placed loosely into the housing 214. In another embodiment, the circuitry 230 can be selectively, sealingly enclosed within the housing 214, where the housing 214 includes a closure 216 removably attached to a body of the housing 214.

The housing 214 is fabricated from a suitably selected material that facilitates inhibiting the effect the material has on the signal being emitted from, for example, the transceiver 122, the Bluetooth component 204, and the Wi-Fi component 202 and passing through the housing material. For example, and without limitation, suitable materials from which the housing 214 may be fabricated include polyethylene, propylene, isoprene, and butylenes (i.e., polyolefins). In other embodiments, the housing 214 is fabricated from any material that enables the POS device 104 to function as described herein.

In one embodiment, the transceiver 122 includes an antenna 232. The antenna 232 includes a looped wire configured to transmit radio signals when current flows through the looped wire. The antenna 232 is any size, shape, and configuration that is suitable for transmitting signals as described herein. For example, the antenna 232 is a tuned circuit configured to transmit radio signals in any radio-based communication system including, but not limited to, Radio Frequency Identification (RFID), Wireless Local Area Network (WLAN), and Wireless Personal Area Network (WPAN) systems. In the example embodiment, the antenna 232 generates a magnetic field when it vibrates at a selected frequency. Specifically, the antenna 232 is configured to vibrate at a frequency of about 13.56 MHz, which is suitable for use in a near field communication (NFC) system.

In the example embodiment, the antenna 232 transmits radio signals to and receives radio signals from, for example, the consumer mobile computing device 102 (shown in FIG. 1) or any other components used in NFC systems. In NFC systems, at least one NFC component generates a magnetic field to inductively transfer currents and, thereby, exchange signals and information with other NFC components positioned within the magnetic field. In the exemplary embodiment, the antenna 232 functions as an NFC component to send and receive signals. The antenna 232 is configured to transmit radio signals to NFC components positioned within the magnetic field of the antenna 232, such as when the consumer mobile computing device 102 is located within a predetermined distance of the POS device 104. Therefore, the magnetic field generated by the antenna 232 defines the active range of the POS device 104. Additionally, the antenna 232 receives radio signals from NFC components when the antenna 232 is positioned within the magnetic field of the NFC components.

The transceiver 122 also includes a radio frequency (RF) interface 234 and an NFC device controller 236. The RF interface 234 and the NFC device controller 236 are powered by the power source 208, and in some embodiments, the power supply 210 or the external display device 220, as is the processor 118 and the memory device 120. The RF interface 234 is configured to receive and transmit RF signals through the antenna 232. The NFC device controller 236 is configured to process the received RF signals and to generate signals to be transmitted by the RF interface 234. The memory device 120 is configured to store data associated with transmitting and receiving the RF signals. The NFC device controller 236 is coupled in communication with the processor 118.

In some embodiments, the POS device 104 may be connected to one or more peripheral devices (not shown). That is, the POS device 104 may communicate various data with one or more peripheral devices. For example, the POS device 104 may communicate with one or more peripheral devices through the Wi-Fi component 202, the Bluetooth component 204, or other suitable means. When the POS device 104 and a peripheral device communicate with each other through one of the wireless communication methods, a connection procedure necessary for a corresponding communication method may be performed. For example, and without limitation, when the POS device 104 and a peripheral device attempt to communicate with each other through the Bluetooth component 204, a pairing procedure necessary for a Bluetooth communication method may be initiated by the POS device 104. Example peripheral devices includes, but are not limited to, barcode readers, receipt printers, card payment signature pads, payment card chip readers, cash drawers, keyboards, mice, and the like.

FIG. 3 is an example configuration of a consumer mobile computing device 102 configured to transmit digital wallet data 306 (i.e., payment credentials) to, for example, the merchant 106. In the example embodiment, the consumer mobile computing device 102 includes a processor 302 for executing instructions. In some embodiments, executable instructions are stored in a memory device 304. The processor 302 includes one or more processing units arranged in, for example, a multi-core configuration. The memory device 304 is any device allowing information such as the digital wallet data 306, executable instructions, and/or written works to be stored and retrieved. The memory device 304 includes one or more computer readable media.

The consumer mobile computing device 102 also includes at least one media output component 308 for presenting information to the consumer 116. The media output component 308 is any component capable of conveying information to the consumer 116. In some embodiments, the media output component 308 includes an output adapter such as a video adapter and/or an audio adapter. An output adapter is operatively coupled to the processor 302 and operatively connectable to an output device such as a display device, a liquid crystal display (LCD), organic light emitting diode (OLED) display, or “electronic ink” display, or an audio output device, a speaker, or headphones.

In some embodiments, the consumer mobile computing device 102 includes an input device 310 for receiving input from the consumer 116. The input device 310 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 308 and the input device 310. The consumer mobile computing device 102 may also include a transceiver 312, which is communicatively connectable to a remote device such as the POS device 104 (shown in FIG. 1). The transceiver 312 may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the consumer 116 via the media output component 308 and, optionally, receiving and processing input from the input device 310. A user interface may include, among other possibilities, a web browser and a consumer application 144 (shown in FIG. 1). Web browsers enable users, such as the consumer 116, to display and interact with media and other information typically embedded on a web page or a website from the server system 124. The consumer application 144 allows the consumer 116 to interact with a storefront application on the POS device 104.

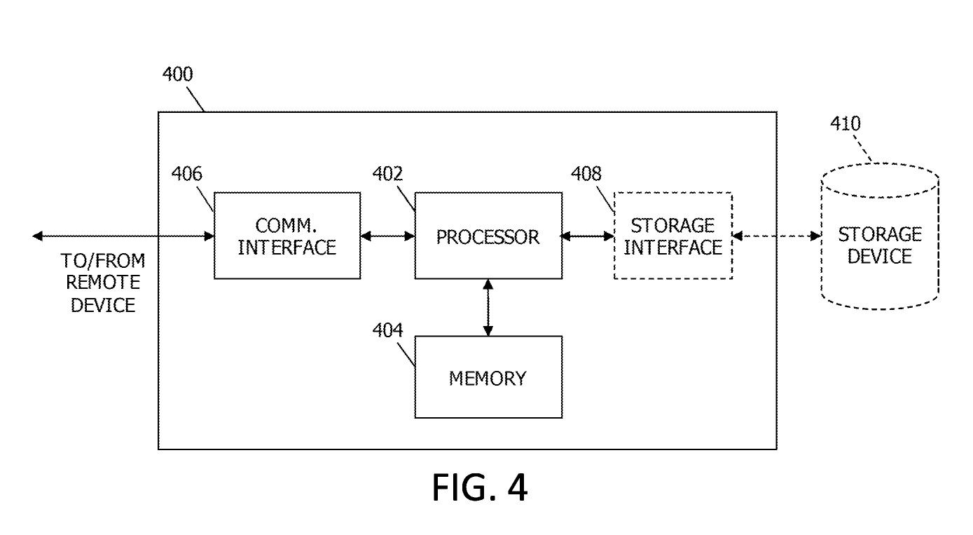

FIG. 4 is an example configuration of a server system 400, such as the server system 124 (shown in FIG. 1). The server system 400 includes, but is not limited to, the database server 136 (shown in FIG. 1). In some embodiments, the server system 400 is substantially like the server system 124. In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as a user system or another server system 400. For example, the communication interface 406 may receive communications from the issuer computing devices 130 via the Internet, as illustrated in FIG. 1.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is like the transaction database 134 (shown in FIG. 1). For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

FIG. 5 is a block diagram of a transaction card account system 500 showing data flow among the consumer mobile computing device 102, a payment processor 502, and a merchant processor 504. In the example embodiment, the system 500 is a transaction card account system such as the payment card network system 100 (shown in FIG. 1). In some embodiments, the payment processor 502 is an interchange network, such as the interchange network 112 (shown in FIG. 1). The consumer mobile computing device 102 is configured to allow consumer 116 (shown in FIG. 1) to access the payment processor 502 and the merchant processor 504 via the POS device 104 (shown in FIG. 1), and electronically transact with the payment processor 502 and/or the merchant processor 504 to purchase goods or services associated with the merchant 106 (shown in FIG. 1). In the example embodiment, the consumer mobile computing device 102 is coupled in communication with the POS device 104. The consumer mobile computing device 102 includes the consumer mobile computing device ID 128, which includes a specific identifier, such as a number, to identify the consumer mobile computing device 102 to facilitate associating the consumer mobile computing device 102 with the purchased good or service. It is noted that different consumer mobile computing devices are assigned unique consumer mobile computing device IDs 128 to associate the transactions to the particular consumer mobile computing device 102.

In the example embodiment, the merchant processor 504 includes a merchant computer device 510. The merchant computer device 510 is a computer device such as the POS device 104 (shown in FIG. 1). The merchant computer device 510 is a service-provided device that is coupled in communication with merchant processor 504. Merchant computer device 510 allows merchant processor 504 to wirelessly communicate purchase data 512 to consumer mobile computing device 102. Merchant processor 504 (e.g., the POS device 104) is configured to transmit purchase data 512 by radio transmission using the circuitry 230 (shown in FIG. 2), such as the NFC-enabled circuitry. The purchase data 512 includes information related to goods and/or services provided by the merchant processor 504. For example, and without limitation, in one embodiment, the merchant processor 504 is associated with airline tickets and the purchase data 512 is product information such as, for example, available seating classes, number of seats available for purchase, and/or available travel services. The consumer mobile computing device 102 transmits the transaction data 514 to the merchant computer device 510 after receiving the purchase data 512 from the merchant computer device 510. The consumer mobile computing device 102 is configured to transmit the transaction data 514 wirelessly via the transceiver 312 (shown in FIG. 3) to the PO S device 104. The transaction data 514 includes transaction information responsive to the purchase data 512, i.e., the transaction data 514 indicates a purchased item identifier associated with the goods and/or services the consumer 116 would like to purchase from the merchant and a payment credential (i.e., the digital wallet data 306).

The merchant processor 504 receives the transaction data 514 and generates a payment authorization request message 524. The payment authorization request message 524 is transmitted to the payment computer device 516 for processing and further transmission to an issuing bank for approval. In one embodiment, the payment computer device 516 includes an interchange computer associated with an interchange. A payment authorization response message 526 is received from the issuing bank and transmitted to the merchant computer device 510 by the payment computer device 516. Additionally, first transaction data 518 are stored at the payment processor 502 after the transaction is processed by the issuing bank. The first transaction data 518 include at least the consumer mobile computing device ID 128 associated with the consumer mobile computing device 102, the digital wallet data 306 associated with the consumer 116, and the transaction data 514 associated with the purchased item.

After completion of the transaction, the merchant computer device 510 generates and transmits a notification message 528 to the consumer mobile computing device 102 indicating that the purchased goods and/or services are available and/or ready to be picked up by the consumer 116 or will be delivered to the consumer 116 associated with consumer mobile computing device 102 as indicated by the associated consumer mobile computing device ID 128.

In the example embodiment, the payment computer device 516 is configured to store and/or track other transaction data 519 associated with other purchased items related to consumer mobile computing device 102. The first transaction data 518 and other transaction data 519 define a total transaction data 521 associated with the consumer mobile computing device 102. Moreover, the payment computer device 516 is configured to track, categorize, organize, and/or analyze the first transaction data 518 and/or the total transaction data 521 and further associate the stored first transaction data 518 and/or the total transaction data 521 with the consumer mobile computing device ID 128 for access by the consumer 116. In one embodiment, the payment computer device 516 is configured to aggregate a monetary value of the stored first transaction data 518 and/or the total transaction data 521 over a period of time.

The consumer mobile computing device 102 is configured to allow the consumer 116 to access the merchant processor 504 and the payment computer device 516, and electronically transact with the merchant computer device 510 and/or the payment computer device 516. In the example embodiment, the consumer mobile computing device 102 is configured to conduct electronic transactions associated with the first transaction data 518 such as, but not limited to, financial transactions, product transactions, and service transactions and to present the transactions to the consumer 116. The consumer mobile computing device 102 is also configured to transmit a report call 520 to the payment processor 502 to request a report message 522, which includes a record of the stored transaction data 518 and/or the total transaction data 521 including financial transactions, product transactions, and service transactions.

The payment computer device 516 stores the first transaction data 518 and/or the total transaction data 521 including at least the consumer mobile computing device ID 128, the digital wallet data 306, and the transaction data 514 for the consumer mobile computing device 102. The consumer 116 may view the transaction data 518 and 521 by transmitting the report call 520 to the payment computer device 516, receiving the report message 522, and displaying the report message 522 using the media output component 308 (shown in FIG. 3) of the consumer mobile computing device 102. More particularly, the payment computer device 516 is configured to transmit the report message 522 including the first transaction data 518 and/or the total transaction data 521 to the consumer mobile computing device 102. The consumer mobile computing device 102 is configured to receive the report message 522 including the first transaction data 518 and/or the total transaction data 521 from the payment computer device 516 for display to the consumer 116.

In the example embodiment, the consumer 116 views goods and/or services offered by the merchant 106 on the external display device 220. Using a unique identifier associated with selected goods and/or services (e.g., a bar code, a QR code, and the like displayed on the external display device 220), the consumer 116 adds the selected items to a digital shopping cart for purchase. The consumer 116 places the consumer mobile computing device 102 near the merchant's POS device 104. The consumer mobile computing device 102 is detected by the POS device 104 and establishes communication over the wireless connection 126. The merchant processor 504 transmits purchase data 512 to the consumer mobile computing device 102, where the purchase data 512 is associated with the selected items. The consumer 116 conducts the transaction with the POS device 104, such as by selecting an option on the input device 310 (shown in FIG. 3) of the consumer mobile computing device 102 to transmit the transaction data 514 associated with the purchased items to the payment computer device 516. Additionally, the POS device 104 receives the consumer mobile computing device ID 128 and associates the transaction data 514 with the particular mobile computing device. The POS device 104 transmits the payment authorization request message 524 and the first transaction data 518 including the consumer mobile computing device ID 128, the digital wallet data 306, and the transaction data 514 to the payment computer device 516. The payment computer device 516 is configured to conduct the transaction with the merchant's POS device 104. Moreover, the payment computer device 516 is configured to store and/or track the consumer mobile computing device ID 128, the digital wallet data 306, and the transaction data 514 for subsequent access by the consumer mobile computing device 102 as described herein.

In some embodiments, the POS device 104 may operate in an offline mode. When the POS device 104 operates in the offline mode, the POS device 104 locally stores the transaction data 514 for later sending to the payment processor 502 after the POS device 104 transitions into an online mode. The POS device 104 may transition to the offline mode when the POS device 104 loses network connectivity (e.g., due to being at a location that lacks network connectivity) or in response to the merchant 106 manually transitioning to the offline mode using a merchant companion application 140 (shown in FIG. 1) configured to communicate directly with the POS device 104.

When the POS device 104 transitions from the offline mode to the online mode, the POS device 104 sends, to the payment processor 502, all the transaction data 514 it has stored. The transmission of the transaction data 514 typically occurs as a large batch. For example, if the POS device 104 has processed hundreds of transactions while in the offline mode, then the POS device 104 may send a batch of payment authorization request messages 524 corresponding to these transactions to the payment processor 502. Typically, the payment processor 502 will receive this batch of requests 524, attempt to authorize each payment associated with each request 524, and send a result back to the POS device 104 indicating which payments were approved and which were declined.

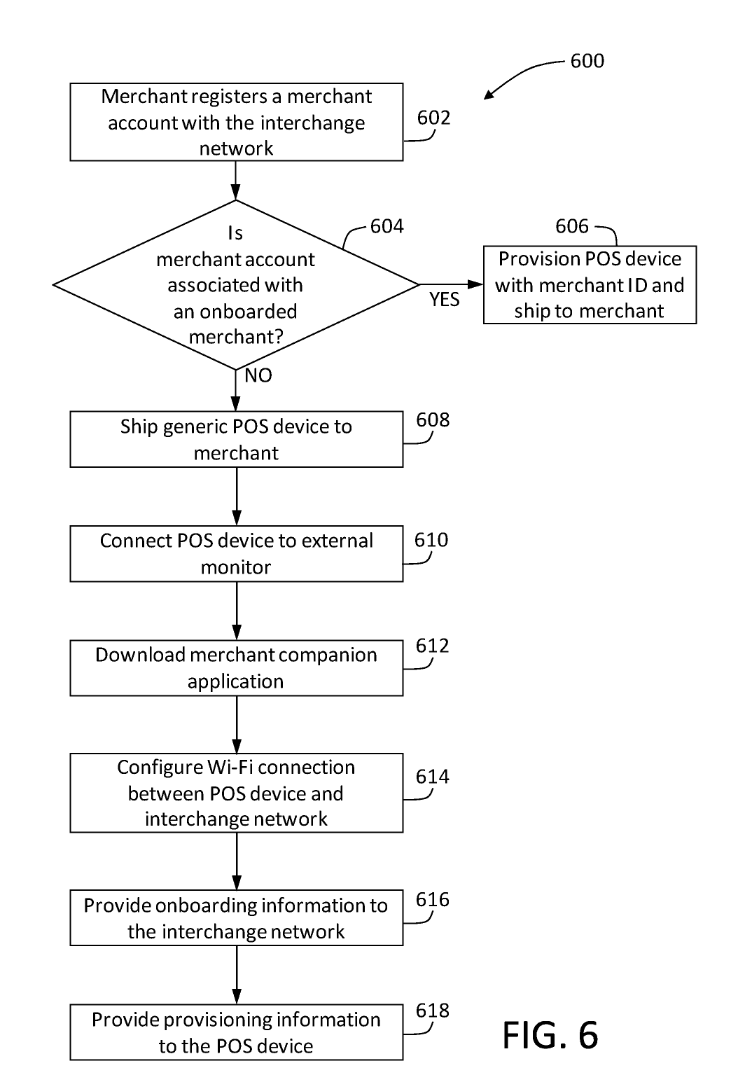

FIG. 6 is a flowchart illustrating an exemplary merchant onboarding process 600 for onboarding a merchant 106 using the POS device 104 (shown in FIG. 1), in accordance with one embodiment of the present invention. In one embodiment, the method 600 may be implemented by the payment card network system 100 (shown in FIG. 1). In the exemplary embodiment, the method 600 relates to the receiving of information from the merchant 106 via the POS device 104 for onboarding the merchant 106 with the interchange network 112 (shown in FIG. 1). While operations within the method 600 are described below with regard to the merchant client system 130 (shown in FIG. 1), the method 600 may be implemented on the merchant client system 130 as well as other such devices and/or systems.

Referring to operation 602, in the example embodiment, the merchant 106 registers a merchant account with the interchange network 112 using, for example, the merchant client system 130 and requests a POS device 104. More specifically, the merchant client system 130 is coupled in communication with the server system 124 (shown in FIG. 1) via the network 114 and provides merchant account details to the interchange network 112. In one embodiment, the merchant client system 130 is a web-based smartphone that accesses the network 114 via a mobile phone network.

Alternatively, the merchant client system 130 is any computing device that may be coupled in communication with the server system 124 via the network 114.

Referring to operation 604, the interchange network 112 determines whether the merchant account is associated with a merchant 106 that is already onboarded with the interchange network 112 (i.e., the merchant 106 has an assigned merchant identifier (MID)). With reference to operation 606, if the merchant 106 is already onboarded with the interchange network 112, the interchange network 112 provisions the POS device 104 to the associated merchant identifier (MID) and ships it to the merchant 106. The POS device is fully functional and ready to be utilized as described in operation 618 below. With reference to operation 608, if the merchant 106 is not onboarded with the interchange network 112, the interchange network 112 ships a non-provisioned POS device 104 that is not provisioned to an MID (i.e., a generic POS device 104) to the merchant 106. Because the generic POS device 104 is not associated with any MID, it cannot be used to process transactions until it is setup and associated with an onboarded merchant.

Referring to operation 610, after receiving the generic or non-provisioned POS device 104, the merchant 106 connects the POS device 104 to an external display device 220 (shown in FIG. 2) to complete the onboarding process and prepare the POS device 104 for processing transactions. For example, in one embodiment, when the POS device 104 is connected to the external display device 220 and powered on, the POS device instructs the merchant 106 to download the merchant companion application 140 (shown in FIG. 1) for direct communication with the POS device 104. When the merchant client system 130 is positioned within a predetermined distance of the POS device 104, a direct link is established via a wireless connection 142 (shown in FIG. 1), for example, via Wi-Fi direct or Bluetooth connection.

Referring to operation 612, the merchant downloads the merchant companion application 140. The merchant client system 130, such as a web-based smartphone, is configured to execute for display the merchant companion application 140. In some embodiments, the merchant companion application 140 may be stored in a cloud-based interface, which may include cloud storage capability as well as any cloud-based API that facilitates communication between the merchant client system 130 and the POS device 104 and/or the consumer mobile computing devices 102. The merchant companion application facilitates transmitting and receiving data between the merchant client system 130 and the POS device 104, the consumer mobile computing devices 102, and the interchange network 112 for provisioning the POS device 104 and processing transactions. In addition, the merchant companion application 140 includes various administrative functions for the merchant 106, such as inventory management, sales tracking, invoice tracking, various analytics, and the like. In the exemplary method 600, the merchant accesses the merchant companion application 140 to communicate with the POS device 104 and the interchange network 112 to provide, for example, onboarding information to establish a merchant ID.

Referring to operation 614, the merchant 106 configures or sets up a Wi-Fi connection between the POS device 104 and the network 114. More specifically, the merchant companion application 140 facilitates establishing a direct link to the POS device 104, for example, via a direct Wi-Fi or Bluetooth connection. The merchant companion application 140 provides a setup wizard that the merchant 106 completes to provide the necessary connection information to establish a Wi-Fi connection to the network 114. The connection information is transferred from the merchant client system 130 via the merchant companion application 140 to the POS device 104, where they are stored, for example, in the memory device 120 (shown in FIG. 1). The POS device 104 then establishes a Wi-Fi connection to the network 114 in accordance with the connection information.

With reference to operation 616, the merchant 106 provides its onboarding information to the interchange network 112, for example, through the POS device 104 via the merchant companion application 140. The POS device 104 stores the onboarding information, for example, in the memory device 120. The onboarding information the merchant provides includes, for example, identification and financial data relating to the merchant 106. The data includes, for example, and without limitation, identifying information of the merchant 106, such as merchant name, business location, and tax identification number, and financial information of the merchant 106, such as bank account details. The identifying information is stored in a memory device and/or database, such as database 134. In one embodiment, the identification data is received from one or more sources including, for example, an existing Member Alert to Control High-Risk Merchants (MATCH) database or system (e.g., a MASTERCARD MATCH® brand database) (not shown) and/or the merchant 106 via one or more of the merchant client systems 130.

Referring to operation 618, after receiving the onboarding information from the merchant 106 and completing the onboarding process, the interchange network provides provisioning information to the POS device 104 to provision the generic POS device 104 with the merchant's newly assigned MID. The POS device is then fully operational and ready to display the merchant's goods and/or services and accept payments from one or more consumer mobile computing devices 102.

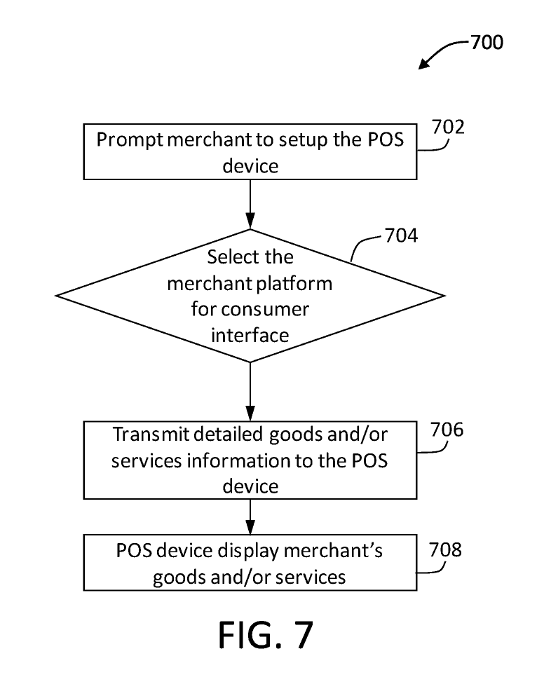

FIG. 7 is a flowchart illustrating an exemplary merchant platform setup process 700 for setting up the POS device 104 (shown in FIG. 1) to display the merchant's goods and/or services on the external display device 220 (shown in FIG. 2), in accordance with one embodiment of the present invention. In one embodiment, the method 700 may be implemented by the payment card network system 100 (shown in FIG. 1). In the exemplary embodiment, the method 700 relates to the merchant 106 transmitting and/or receiving data with the POS device 104 for setting up a store. While operations within the method 700 are described below with regard to the merchant client system 130 (shown in FIG. 1), the method 700 may be implemented on the merchant client system 130 as well as other such devices and/or systems.

Referring to operation 702, in the example embodiment, the POS device 104 displays a message on the external display device 220 prompting the merchant 106 to setup the POS device 104 for displaying the merchant's goods and/or services. More specifically, the merchant 106 connects the POS device 104 to the external display device 220 via the HDMI connection, and if necessary, attaches the power source 208 (shown in FIG. 2) to the POS device 104 to provide power to the POS device 104. The POS device 104 and the external display device 220 are powered on, and after startup, the POS device 104, which is provisioned to the merchant's MID, displays the setup message.

The setup message, for example, may prompt the merchant 106 to choose one of several types of merchant platforms including, without limitation, an online store platform, a donations platform, a hosted payments platform, or a custom platform. In the exemplary embodiment, the online store platform may include a traditional online store interface that displays pages of the merchant's goods and/or services with an option to purchase one or more items during a checkout process. The donations platform may include an image or images related to a cause that is accepting donations, wherein an option for donating to the cause is provided. The hosted payments application may include a crowdfunding platform that provides the merchant for accepting payments for funding, for example, a project, venture, event, or the like. The custom platform may be selected by the merchant 106 and allows the merchant to develop its own custom application that utilizes SDKs and APIs of the POS device 104 to provide a consumer a more interactive purchase scenario, such as, booking airline tickets or purchasing movie passes and selecting seats.

Referring to operation 704, the merchant 106 selects the merchant platform using for example, the merchant client system 130 via the merchant companion application 140. For example, the client system 130 is coupled in communication with the POS device 104 via the wireless connection 142 (shown in FIG. 1) and the POS device 104 registers the merchant's selection. The POS device may transmit additional data to the merchant companion application 140 that is specific to the selected platform. The merchant companion application 140 may then display setup instructions and or execute a setup wizard via the merchant client system 130 for setting up the selected platform.

Referring to operation 706, the merchant 106 transmits detailed goods and/or services information to the POS device 104 via the merchant companion application 140. For example, the merchant 106 may upload images of various items available for purchase and provide additional details such as price, quantity, item name, description, etc. For each item that is uploaded, the merchant companion application 140 may add a unique item identifier (e.g., a bar code, a QR code, and the like) to the item description and/or image. In addition, where the merchant client system 130 is a mobile smartphone including a camera, the merchant companion application 140 may provide an option for taking a photograph of the item and an interface for providing the detailed information. When the merchant 106 has completed added items, the merchant companion application 140 may transmit the information to the POS device 104 for display. With reference to operation 708, the POS device 104 may display the merchant's goods and/or services via the external display device 220.

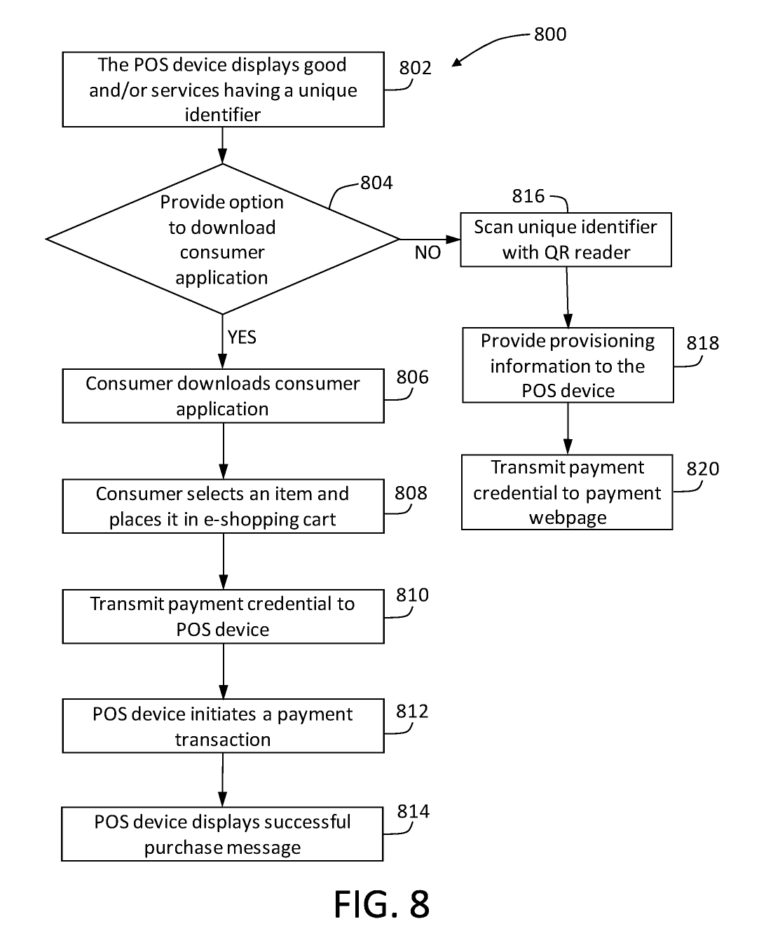

FIG. 8 is a flowchart illustrating an exemplary consumer transaction process 800 utilizing the POS device 104 (shown in FIG. 1), in accordance with one embodiment of the present invention. In one embodiment, the method 800 may be implemented by the payment card network system 100 (shown in FIG. 1). In the exemplary embodiment, the method 800 relates to the consumer 116 interacting with the POS device 104 to perform one or more transactions with the merchant 106. While operations within the method 800 are described below with regard to the consumer mobile computing device 102 (shown in FIG. 1), the method 800 may be implemented on the consumer mobile computing device 102 as well as other such devices and/or systems.

Referring to operation 802, in the example embodiment, the POS device 104 displays the merchant's goods and/or services, for example, as a slideshow on the external display device 220 (shown in FIG. 2). As described above, each of the items include a unique item identifier, such as a bar code, a QR code, and the like. At operation 804, the POS device 104 also displays a link or instruction to the consumer 116 for downloading the consumer application 144 (shown in FIG. 1) to the consumer mobile computing device 102.

Referring to operation 806, the consumer 116 downloads the consumer application 144. The consumer mobile computing device 102, such as a web-based smartphone, may be configured to execute for display the consumer application 144. In some embodiments, the consumer application 144 may be stored in a cloud-based interface, which may include cloud storage capability as well as any cloud-based API that facilitates communication between the POS device 104 and/or the merchant client system 130 via the merchant companion application 140. The consumer application 144 facilitates transmitting and receiving data between the consumer mobile computing device 102 and the POS device 104 for viewing and/selecting the merchant's items for purchase. For example, the consumer application 144 may communicate with the POS device 104 for receiving the same data displayed on the external display device 220 and/or for scanning the unique item identifier (e.g., the bar code, QR code, etc.). At operation 808, the consumer 116 selects at least one item for placing in an electronic shopping cart for purchase.

Referring to operation 810, the consumer 116 transmits a payment credential (e.g., the digital wallet data 306) to the POS device 104 to perform the purchase transaction. At operation 812, after receiving the payment credential, the POS device initiates the payment transaction, for example, in accordance with the data flow shown in FIG. 5. At operation 814, after receiving the payment authorization response message 526 (shown in FIG. 5), the POS device displays a successful purchase message on the external display device 220 and transmits the notification message 528 to the consumer mobile computing device 102 via the consumer application 144 indicating that the purchased goods and/or services are available and/or ready to be picked up by the consumer 116 or will be delivered to the consumer 116 associated with consumer mobile computing device 102.

Referring to operation 804, the consumer 116 may optionally choose not to download the consumer application 144. Rather, at operation 816, the consumer 116 may use the consumer mobile computing device 102 to scan the unique item identifier (e.g., the bar code, QR code, etc.), for example by taking a photograph of the identifier or using a scanning application, such as a QR code scanner. At operation 818, the consumer mobile computing device 102 may open a web browser and display a payment webpage including the scanned item. Referring to operation 820, the consumer 116 transmits a payment credential (e.g., the digital wallet data 306) to the payment webpage to perform the purchase transaction.

Any actions, functions, operations, and the like recited herein may be performed in the order shown in the figures and/or described above, or may be performed in a different order. Furthermore, some operations may be performed concurrently as opposed to sequentially. Although the methods are described above, for the purpose of illustration, as being executed by an example system and/or example physical elements, it will be understood that the performance of any one or more of such actions may be differently distributed without departing from the spirit of the present invention.

A computer-readable storage media or medium comprising a non-transitory medium may include an executable computer program stored thereon and for instructing one or more processing elements to perform some or all of the operations described herein, including some or all of the operations of the computer-implemented method. The computer program stored on the computer-readable medium may instruct the processor and/or other components of the system to perform additional, fewer, or alternative operations, including those discussed elsewhere herein.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only, and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above memory types are example only, and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short-range communications protocols.

The term “communication component,” “communication interface,” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3 GPP standards, or other standards, and configured to receive and transmit signals via a communications network.

The term “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

What is claimed is:

1. A method for utilizing a portable point-of-sale device for onboarding a merchant with an interchange network, said method comprising the operations of:
coupling the portable point-of-sale device to an external display device;
using a merchant client device, downloading a merchant companion application configured to communicate directly with the portable point-of-sale device;
configuring a network connection between the portable point-of-sale device and the interchange network utilizing the merchant companion application; and
providing merchant onboarding information to the interchange network via the portable point-of-sale device utilizing the merchant companion application.

2. The method in accordance with claim 1, further comprising the operations of:
registering a merchant account with the interchange network; and
requesting the point-of-sale device.

3. The method in accordance with claim 2, further comprising the operations of:
determining whether the merchant account is associated with an onboarded merchant; and
if the merchant is an onboarded merchant, provisioning the point-of-sale device with a merchant identifier corresponding to the onboarded merchant.

4. The method in accordance with claim 1, further comprising the operation of receiving the point-of-sale device from the interchange network.

5. The method in accordance with claim 1, wherein coupling the portable point-of-sale device to an external display device further comprises the operation of coupling a power source to the point-of-sale device.

6. The method in accordance with claim 1, wherein coupling the portable point-of-sale device to an external display device further comprises the operation of receiving an instruction from the point-of-sale device to download the merchant companion application.

7. The method in accordance with claim 1, further comprising the operation of establishing a direct link to the point-of-sale device with the merchant client device.

8. The method in accordance with claim 7, wherein establishing the direct link further comprises the operation of positioning the merchant client device within a predetermined distance of the point-of-sale device.

9. The method in accordance with claim 1, wherein configuring a network connection between the portable point-of-sale device and the interchange network further comprises the operation of providing network connection information to the point-of-sale device utilizing the merchant client device.

10. The method in accordance with claim 1, further comprising the operation of receiving a merchant identifier from the interchange network for provisioning the point-of-sale device.

11. A portable point-of-sale device comprising:
a memory device for storing data;
one or more wireless communication modules; and
a processor communicatively coupled to said one or more wireless communication modules and said memory device, said processor programmed to:
present an option to a merchant to download a merchant companion application to a merchant client device,
establish a direct link to the merchant companion device,
receive network connection information from the merchant companion application via the direct link,
establish a network connection to an interchange network via said one or more wireless communication modules in accordance with the received network connection information,
receive onboarding information from the merchant companion application via the direct link, and
transmit the received onboarding information to the interchange network.

12. The portable point-of-sale device in accordance with claim 11, said processor being programmed to, as part of establishing the direct link:
establish a wireless connection to the merchant client device via one of said one or more wireless communication modules.

13. The portable point-of-sale device in accordance with claim 12, said one or more wireless communication modules comprising one or more of the following: a Wi-Fi component and a Bluetooth component.

14. The portable point-of-sale device in accordance with claim 11, said processor being programmed to, as part of establishing the direct link:
initiate a Bluetooth pairing procedure with the merchant client device.

15. The portable point-of-sale device in accordance with claim 11,
said processor programmed to store the received network connection information in said memory device.

16. The portable point-of-sale device in accordance with claim 11, said processor being programmed to, as part of establishing the network connection to the interchange network:
establish a wireless connection to a network coupled in communication to the interchange network.

17. The portable point-of-sale device in accordance with claim 11, said processor programmed to store the received onboarding information in said memory device.

18. The portable point-of-sale device in accordance with claim 11, said onboarding information including identification and financial data relating to the merchant.

19. The portable point-of-sale device in accordance with claim 11, said processor programmed to receive a merchant identifier from the interchange network, the merchant identifier corresponding to the merchant.

20. The portable point-of-sale device in accordance with claim 19, said processor programmed to provision said portable point-of-sale device with the merchant identifier.
